(19) United States
(12) Patent Application Publication
(10) Pub. No.: US 2006/0048768 A1
(43) Pub. Date: Mar. 9, 2006

(54) Dinner plate warmer

(76) Inventors: Michel Champagne, St-Jean Richelieu (CA); Michel Blais, St-Jean Richelieu (CA)

Correspondence Address: INVENTARIUM, SUITE 1607, 4050, ROSEMONT BLVD., MONTREAL, QC, H1X2M4, CA

(21) Appl. No.: 10/935,144

(22) Filed: Sep. 8, 2004

(51) Int. Cl. A47J 36/24

(52) U.S. Cl. 126/246; 126/375.1

(57) ABSTRACT

A dinner plate warmer uses hot or warm water that is poured into it from a kettle or other sources of hot water by way of a hole. Steam can escape through a plurality of small holes that distributes heat evenly as well as avoiding water overflow when handling the dinner plate warmer, with or without a dinner plate in it.

### BACKGROUND OF THE INVENTION

1. Field of the Invention

This invention relates generally to kitchen ware but more particularly to a plate warmer.

2. Background

Some people want their food to remain hot for a long time but unfortunately dinner plates do not tend to keep food for a long time. The prior art shows a variety of plate warmers, teapot warmers, and related kitchen ware warmers. These warmers use various materials or compounds to keep warmth that has been previously imparted into them by various heating means such as an oven or stovetop burner.

### SUMMARY OF THE INVENTION

This dinner plate warmer uses hot or warm water that is poured into it from a kettle or other sources of hot water by way of a hole. Steam can escape through a plurality of small holes that distributes heat evenly as well as avoiding water overflow when handling the dinner plate warmer, with or without a dinner plate in it. Dinner plates or soup bowls or any such dinnerware can fit in the dinner plate warmer, the name being used here being generic for ease of description and not as a limiting factor.

Advantages of this invention reside in its, ease of use, ease of cleaning and simplicity with the use of an inexpensive material, water, to keep a meal, placed in a dinner plate, hot, and that it can be used with practically any type of round dinner plates so that no special dinner ware needs to be purchased.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

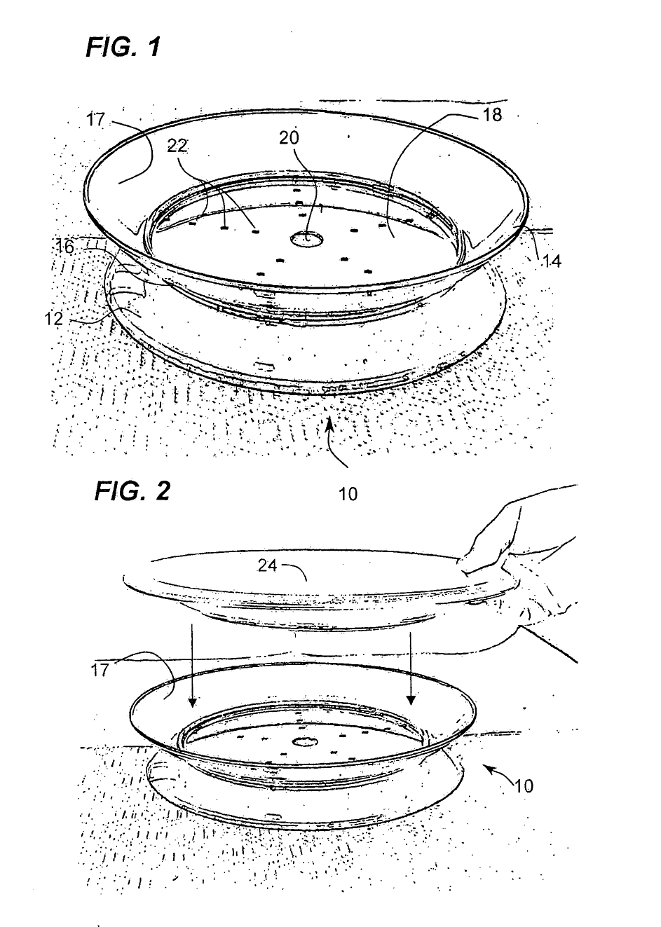

FIG. 1 Perspective view of the dinner plate warmer.

FIG. 2 Perspective view of the dinner plate warmer in relation with a dinner plate.

### DETAILED DESCRIPTION OF THE PREFERRED EMBODIMENT

A dinner plate warmer (10) has a lower water containing section (12) and an upper plate supporting section (14). The lower water containing section (12) and the upper plate supporting section (14) are both releasably connected by any of a variety of suitable releasable connecting means (16) comprising, but not limited to, threadable connection or engagement notches connections.

The upper section (14) has a flared part (17) designed for receiving a dinner plate or any such dinnerware and extending integrally from a bottom part (18) which has a large center hole (20). The large hole is for filling the lower section (12) with water until it reaches just below the center hole (20). Radiating from the large center hole are a plurality of small holes (22) for evacuating vapor as well as for draining water that may overflow during handling.

The lower (12) and upper (14) sections being separable makes it easy to clean the parts since the bottom part (18) is part of the upper section (14), which leaves a large opening for the lower section (12).

The flared part (17) creates a recess configured and sized so that a dinner plate (24) can rest within so as to stay in place during the course of a meal.

1. A dinner plate warmer comprising:
a lower water containing section and an upper plate supporting section;
said lower water containing section and said upper plate supporting section both being releasably connected together by a releasable connecting means;
said upper section having a flared part extending integrally from a bottom part;
said bottom part having a large center hole being used for filling said lower section with water;
radiating from said large center hole are a plurality of small holes for evacuating vapor as well as for draining water that may overflow during handling.

2. A dinner plate warmer as in claim 1 wherein:
said flared part creating a recess configured and sized for a dinner plate so that says dinner plate can stay in place during the course of a meal.

3. A dinner plate warmer as in claim 1 wherein:
said releasable connecting means taken from the group comprising, but not limited to, threadable connection or engagement notches connection.
